(19) United States
(12) Patent Application Publication
(10) Pub. No.: US 2014/0321279 A1
(43) Pub. Date: Oct. 30, 2014

(54) RANDOM EARLY DROP BASED PROCESSING CIRCUIT AND METHOD FOR TRIGGERING RANDOM EARLY DROP BASED OPERATION ACCORDING TO AT LEAST TRIGGER EVENT GENERATED BASED ON SOFTWARE PROGRAMMABLE SCHEDULE

(71) Applicant: MEDIATEK INC., Hsin-Chu (TW)

(72) Inventors: Cheng-Ying Yu, Hsinchu County (TW); Yao-Chun Fang, Tainan City (TW)

(73) Assignee: MEDIATEK INC., Hsin-Chu (TW)

(21) Appl. No.: 14/225,449

(22) Filed: Mar. 26, 2014

Related U.S. Application Data
(60) Provisional application No. 61/815,922, filed on Apr. 25, 2013.

(51) Int. Cl. H04L 12/823

(52) U.S. Cl. CPC H04L 47/326
USPC 370/235

(57) ABSTRACT

A random early drop (RED) based processing circuit includes a scheduler, an RED-based decision logic and a controller. The scheduler generates a trigger event according to an RED-based operation schedule. The scheduler is coupled to a software interface, and the RED-based operation schedule in the scheduler is programmed via the software interface. The RED-based decision logic performs at least a first RED-based operation to generate a first RED decision accordingly. The controller receives at least the trigger event, and triggers the RED-based decision logic to perform the first RED-based operation according to at least the trigger event.

### CROSS REFERENCE TO RELATED APPLICATIONS

This application claims the benefit of U.S. provisional application No. 61/815,922, filed on Apr. 25, 2013 and incorporated herein by reference.

### BACKGROUND

The disclosed embodiments of the present invention relate to congestion avoidance in a network environment, and more particularly, to a random early drop (RED) based processing circuit and method for triggering an RED-based operation (e.g., a weighted random early drop (WRED) operation) according to at least a trigger event (such as a time-based trigger event) generated based on a software programmable schedule.

In general, a network device (e.g., a switch) has a packet buffer for buffering packets transmitted from one or more packet sources. The packet buffer may be a dynamic random access memory (DRAM) with a limited memory size. If an overall line rate (data rate) of the ingress traffic is higher than an overall line rate (data rate) of the egress traffic, the number of packets arriving at the packet buffer is larger than the number of packets released from the packet buffer. In a worst case, the network device would suffer from packet congestion in the packet buffer.

To detect and avoid congestion, a congestion avoidance technique may be employed. For example, a cruder packet drop mechanism called tail drop may be used. However, the tail drop treats traffic of all ports/queues equally and does not differentiate between classes of services. When the packet buffer is full and the tail drop is in effect, newly arriving packets of all ports/queues are dropped until the congestion is eliminated and the packet buffer is no longer full. In other words, the packet buffer is allowed to fill to its maximum size, and then any new packets are simply discarded. As a result, when the packet buffer is already full and there is a sudden burst of packet traffic from one or more hosts, the network device would lose all incoming packets simultaneously, thus resulting in poor packet forwarding performance.

An improved congestion avoidance technique may be used to reduce the chances of tail drop due to packet buffer full. For example, a weighted random early drop (WRED) mechanism may be used to selectively drop packets when the output interface begins to show signs of congestion. However, the WRED operation is a hardware costly operation. For example, multiple hardware-based WRED circuits are needed to make WRED decisions for multiple ports/queues, respectively.

### SUMMARY

In accordance with exemplary embodiments of the present invention, a random early drop (RED) based processing circuit and method for triggering an RED-based operation (e.g., a weighted random early drop (WRED) operation) according to at least a trigger event generated based on a software programmable schedule are proposed to solve the above-mentioned problem.

According to a first aspect of the present invention, an exemplary random early drop (RED) based processing circuit, such as a weighted random early drop (WRED) processing circuit, is disclosed. The RED based processing circuit includes a scheduler, a RED-based decision logic and a controller. The scheduler is configured to generate a trigger event according to a RED-based operation schedule. The scheduler is coupled to a software interface, and the RED-based operation schedule in the scheduler is programmed via the software interface. The RED-based decision logic is configured to perform at least a first RED-based operation to generate a first WRED decision accordingly. The controller is configured to receive at least the trigger event, and trigger the RED-based decision logic to perform the first RED-based operation according to at least the trigger event.

According to a second aspect of the present invention, an exemplary random early drop (RED) based processing method, such as a weighted random early drop (WRED) processing method, is disclosed. The exemplary RED based processing method includes: programming an RED-based operation schedule via a software manner; generating a trigger event according to the RED-based operation schedule; and referring to at least the trigger event for triggering a RED-based decision logic to perform at least a first RED-based operation to generate a first RED decision accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a WRED processing circuit according to a first embodiment of the present invention.

FIG. 2 is a diagram illustrating a software programmable memory according to an embodiment of the present invention.

FIG. 3 is a diagram illustrating an alternative design of the WRED operation schedule stored in the software programmable memory shown in FIG. 2.

FIG. 4 is a block diagram illustrating a WRED processing circuit according to a second embodiment of the present invention.

FIG. 5 is a block diagram illustrating a WRED processing circuit according to a third embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The concept of the present invention is using shared weighted random early drop (WRED) hardware to serve multiple WRED calculation requests for multiple monitored WRED targets (e.g., network ports of the network device or queues of network ports of the network device). In this way, a low-cost WRED mechanism can be realized. Besides, the WRED operations are scheduled based on a software programmable schedule. The user is allowed to define the sequence of WRED operations according to any trigger condition and/or application requirement, thus improving the flexibility of WRED operation scheduling. For example, the WRED operations are scheduled based on predetermined time intervals defined by the software programmable schedule, rather than unpredictable packet arrivals. Hence, when the line rate is high, the inaccuracy introduced by a typical WRED update interval between two consecutive packet arrivals can be avoided. Therefore, the present invention provides an improved WRED design which can maintain the WRED accuracy while reducing the hardware cost. Moreover, the WRED operation on unlikely congested port/queue may be skipped for power saving.

For clarity and simplicity, the following uses a WRED processing circuit as an example to illustrate technical features of the present invention. However, it should be noted that the same concept may be applied to any random early drop (RED), also known as random early detection or random early discard, based processing circuit. In other words, the terms “WRED” and “RED-based” may be interchangeable without departing from the spirit of the present invention. These alternative designs all fall within the scope of the present invention.

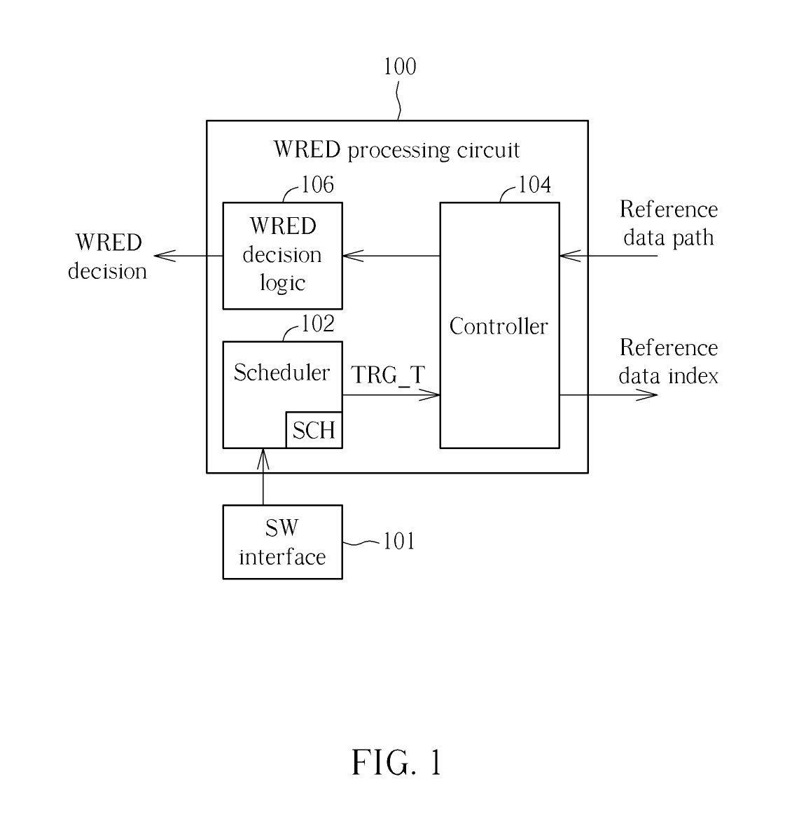

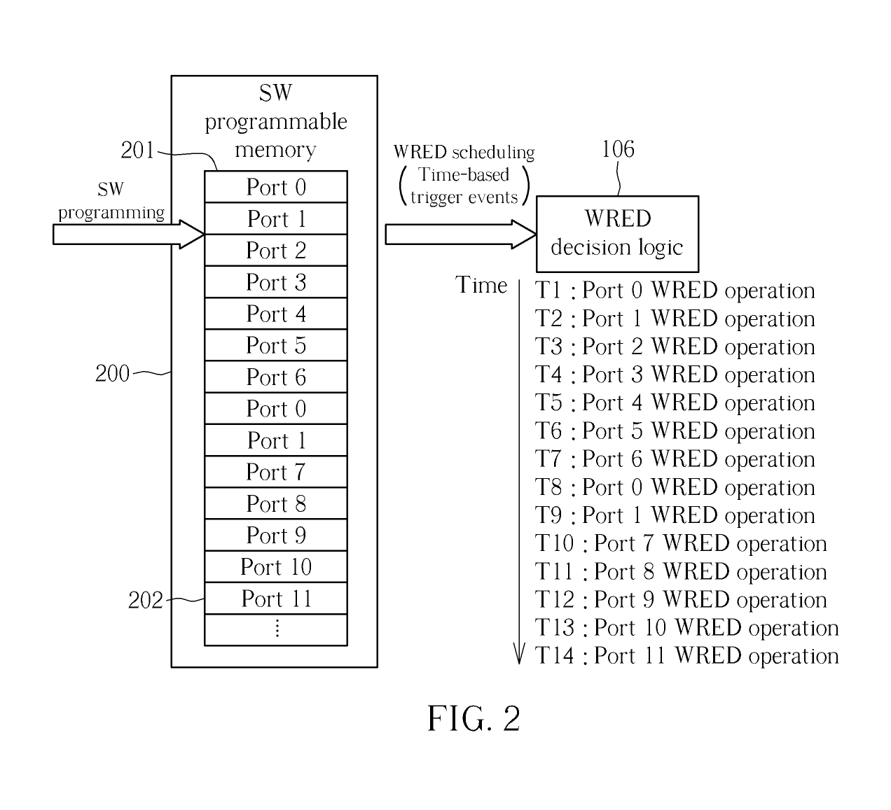

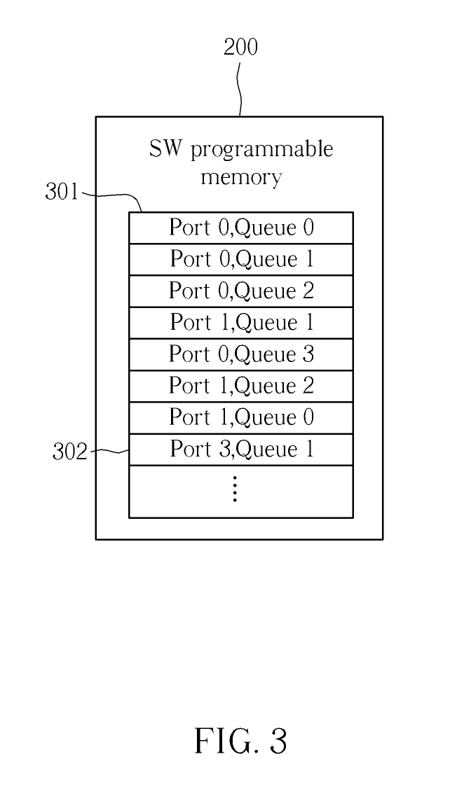

FIG. 1 is a block diagram illustrating a WRED processing circuit according to a first embodiment of the present invention. The WRED processing circuit 100 may be employed in a network device such as a switch. In this embodiment, the WRED processing circuit 100 includes a scheduler 102, a controller 104 and a WRED decision logic 106. The scheduler 102 is configured to generate a time-based trigger event TRG_T to the controller 104 according to a WRED operation schedule SCH. In one exemplary design, the scheduler 102 may be simply implemented using a memory device. Please refer to FIG. 2, which is a diagram illustrating a software programmable memory according to an embodiment of the present invention. The software programmable memory 200 has a WRED operation schedule 201 stored therein, and may be used as the scheduler 102 shown in FIG. 1. The WRED operation schedule 201 includes a plurality of entries 202, each storing an index value of a monitored WRED target. Taking the schedule design in FIG. 2 for example, each monitored WRED target is a network port of the network device. Therefore, an index value in a schedule entry may simply record a port number. Specifically, one network port may have a plurality of queues allocated in the packet buffer. Different queues of the same network port are associated with a plurality of difference services, such that packets of the same service are stored in the same queue. Hence, when a WRED operation is triggered for a selected network port in one time interval (time slot), the WRED decision logic 106 may generate a WRED decision which includes WRED calculation results for all queues in the selected network port. However, this is for illustrative purposes only, and is not meant to be a limitation of the present invention. For another example, the monitored WRED target may be one queue of a network port of the network device. FIG. 3 is a diagram illustrating an alternative design of the WRED operation schedule stored in the software programmable memory 200 shown in FIG. 2. In this embodiment, the WRED operation schedule 301 includes a plurality of entries 202, each storing an index value of a queue of a network port. Therefore, an index value in a schedule entry may simply record a port number and a queue number. Hence, when a WRED operation is triggered for a selected queue in one time interval, the WRED decision logic 106 may generate a WRED decision which includes one WRED calculation result for the selected queue only. This also falls within the scope of the present invention.

Assume that each monitored WRED target is one network port, as illustrated in FIG. 2. The SW programmable memory 200 (i.e., scheduler) cyclically reads and outputs index values in the entries 202 one by one to thereby set and generate the time-based trigger event once in each of a plurality of time intervals (e.g., T1, T2, . . . T14 in FIG. 2). Hence, based on setting of the WRED operation schedule 201, the WRED decision logic 106 generates one WRED decision during each of the time intervals T1-T14 in response to a corresponding time-based trigger event which specifies the network port to which the WRED calculation is applied. As the WRED mechanism is employed by the network device for congestion avoidance, the index values should be properly set to make higher-priority ports have more WRED operations in one schedule cycle (e.g., T1-T14) and lower-priority ports have fewer WRED operations in the same schedule cycle (e.g., T1-T14).

It is possible that at least one network port/queue of the network device is less frequently used for dealing with packets. For example, the packet traffic an e-mail service is generally low. Hence, the WRED operation of such unlikely congested port/queue may be skipped for power saving. In other words, no matter whether a packet is received or not, a WRED operation would never be triggered for an unlikely congested port/queue. In one exemplary design, an index value of at least one specific network port or at least one specific queue may be excluded from the WRED operation schedule. In this way, no WRED operation would be scheduled for the at least one specific network port/queue. The power consumption of the proposed WRED processing circuit is reduced accordingly.

As shown in FIG. 1, the scheduler 102 is coupled to a software interface 101. Hence, the WRED processing circuit 100 allows the WRED operation schedule SCH in the scheduler 102 to be programmed via the software interface 101. The user of the network device may manually configure the WRED operation schedule SCH according to the actual network port/queue condition of the network device. For example, network ports Port 0 and Port 1 are high line rate ports, and thus are more important and should have higher priority. As shown in FIG. 2, the WRED operation schedule 201 is set to schedule more WRED operations to the network ports Port 0 and Port 1. In other words, the occurrence frequency of WRED operations for each of the high-priority network ports Port 0 and Port 1 would be higher than that of other low-priority network ports (e.g., Port 2-Port 11). Since the WRED operation schedule 201 is not fixed in the schedule 102, the WRED operation schedule 201 can be dynamically adjusted based on the actual operational condition of the network device, thus achieving better congestion avoidance performance due to flexibility of WRED operation scheduling.

The controller 104 in FIG. 1 receives each time-based trigger event TRG_T scheduled and outputted from the scheduler 102, and then triggers the WRED decision logic 106 to perform a corresponding WRED operation in response to the current time-based trigger event. In other words, when triggered by the controller 104, the WRED decision logic 106 performs a WRED operation for a monitored WRED target (e.g., one network port or one queue) to generate a WRED decision (e.g., multiple WRED calculation results for all queues of a network port, or a single WRED calculation result for one queue of a network queue) accordingly. The WRED decision tells whether a packet source should decrease its transmission rate to mitigate/eliminate the congestion. By dropping some packets early rather than waiting until the queue is full, WRED avoids dropping a large number of packets at once. Thus, WRED allows the transmission line to be used fully at all times.

In a case where the monitored WRED target is one queue of a network port, the WRED operation may include calculating a packet drop probability Probability_{drop} based on a minimum threshold Thresholdₘᵢₙ, a maximum threshold Thresholdₘₐₓ, a maximum packet drop probability Probabilityₘₐₓ, and an average queue length Queue_{avg}, and making the WRED decision based on the calculated packet drop probability Probability_{drop}. The packet drop probability calculation may be represented using following equation.

$${probability}_{drop} = \frac{{Queue}_{avg} - {Threshold}_{min}}{{Threshold}_{max} - {Threshold}_{min}} \cdot {probability}_{max} \qquad ( 1 )$$

The average queue length Queue_{avg} is a weighted average (moving average) derived from a previous average queue length and a current queue length. When the controller 104 receives a trigger event (e.g., the time-based trigger event in this embodiment), the controller 104 requests parameters, including Queue_{avg}, Thresholdₘᵢₙ, Thresholdₘₐₓ and Probabilityₘₐₓ, from a circuit element (not shown), and then provides the received parameters needed for WRED calculation to the WRED decision logic 106. As can be seen from FIG. 2, a WRED operation for one monitored WRED target (e.g., a network port or a queue) is regularly performed by the WRED decision logic 106 according to the WRED operation schedule 201. Thus, the inaccuracy introduced by a typical WRED update interval between two consecutive arriving packets can be avoided.

The WRED processing circuit 100 shown in FIG. 1 operates under a time-based trigger mode such that the WRED decision logic 106 can be implemented using shared computation hardware for performing WRED operation for a monitored WRED target in one time interval. Since the WRED decision logic 106 operates in a time-division manner, it does not need to have multiple sets of computation hardware dedicated to performing respective WRED operations for multiple monitored WRED targets. Therefore, the hardware cost can be effectively reduced.

It should be noted that the WRED processing circuit 100 shown in FIG. 1 is for illustrative purposes only. Any WRED processing circuit using the proposed software programmable WRED operation scheduling to regularly or periodically generate one time-based trigger event to request WRED operation for a designated WRED target (e.g., a network port or a queue of one network port) falls within the scope of the present invention. For example, the present invention further proposes a hybrid-mode WRED processing circuit which reacts to at least one of a received time-based trigger event and a received packet-based trigger event.

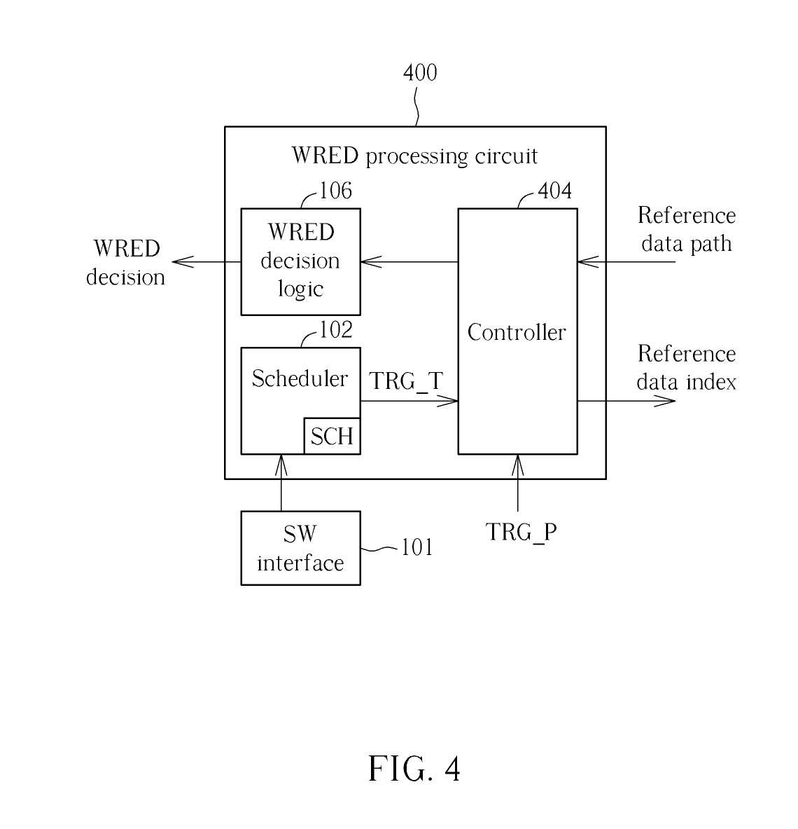

Please refer to FIG. 4, which is a block diagram illustrating a WRED processing circuit according to a second embodiment of the present invention. The WRED processing circuit 400 is a hybrid-mode WRED processing circuit. The major difference between WRED processing circuits 100 and 400 is the controller 404 that is further configured to receive a packet-based trigger event TRG_P. The packet-based trigger event TRG_P may be a packet arrival event or a packet release event. Ina case where the packet-based trigger event TRG_P is a packet arrival event, the packet-based trigger event TRG_P is generated each time a packet arrives at a monitored WRED target (e.g., a network port or a queue of one network port). In another case where the packet-based trigger event TRG_P is a packet release event, the packet-based trigger event TRG_P is generated each time a packet is released from a monitored WRED target (e.g., a network port or a queue of one network port). As mentioned above, the scheduler 102 outputs one time-based trigger event TRG_T in one scheduled time interval (time slot). When there is no packet-based trigger event TRG_P happening in the current time interval, the WRED processing circuit 400 operates like the WRED processing circuit 100. That is, the controller 404 triggers the WRED decision logic 106 to perform the WRED operation for a designated WRED target according to the WRED target information (e.g., port number or queue number) specified in the time-based trigger event TRG_T. However, when the time-based trigger event TRG_T and the packet-based trigger event TRG_P are simultaneously received by the controller 404, the controller 404 would serve the packet-based trigger event TRG_P first to trigger the WRED decision logic 106. By way of example, the controller 404 may directly ignore the time-based trigger event TRG_T, and trigger the WRED decision logic 106 to perform the WRED operation for a designated WRED target according to WRED target information (e.g., packet destination information) specified in the packet-based trigger event TRG_P.

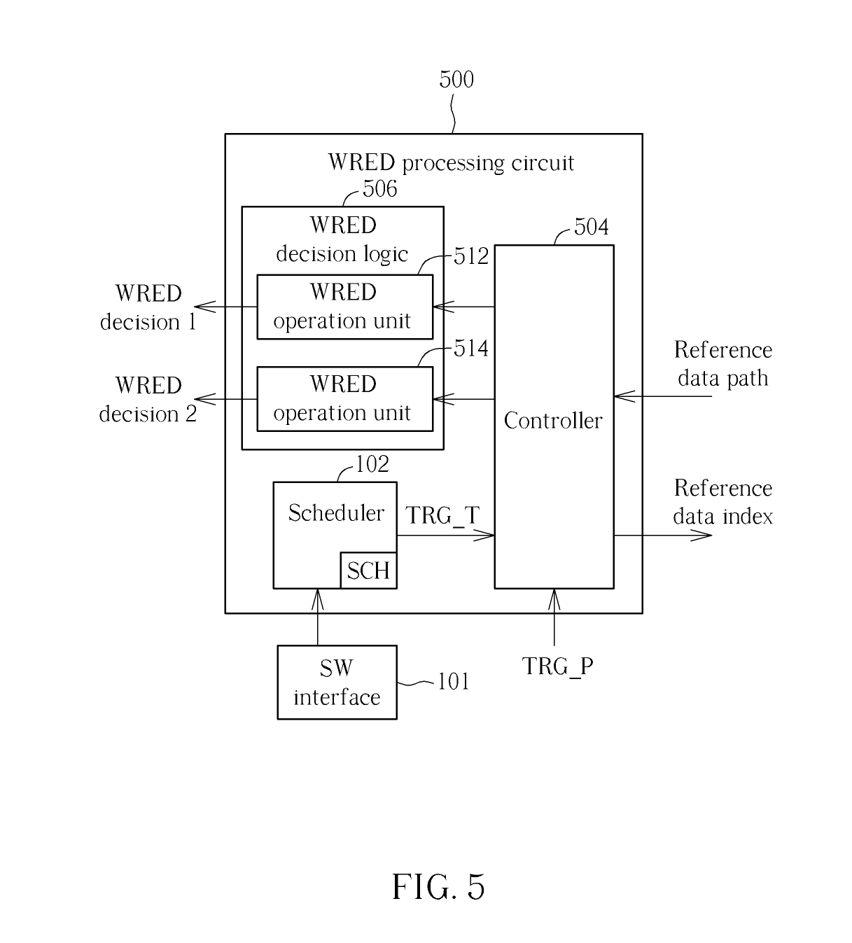

FIG. 5 is a block diagram illustrating a WRED processing circuit according to a third embodiment of the present invention. The WRED processing circuit 500 is another hybrid-mode WRED processing circuit. The major difference between WRED processing circuits 100 and 400 is the controller 504 and the WRED decision logic 506. In this embodiment, the WRED decision logic 506 has two WRED operation units that can operate independently. That is, the WRED operation unit 512 is configured to perform one WRED operation to generate one WRED decision; and the WRED operation unit 514 is configured to perform another WRED operation to generate another WRED decision. Regarding the controller 504, it is further configured to receive a packet-based trigger event TRG_P, where the packet-based trigger event TRG_P may be a packet arrival event or a packet release event. Since two WRED operation units 512, 514 can operate independently, the controller 504 triggers the WRED operation unit 512 according to the time-based trigger event TRG_T, and triggers the WRED operation unit 514 according to the packet-based trigger event TRG_P. Specifically, the WRED operation unit 512 operates like the WRED decision logic 106 shown in FIG. 1, and have the same aforementioned benefits/advantages possessed by the WRED decision logic 106.

As mentioned above, the scheduler 102 outputs one time-based trigger event TRG_T in one scheduled time interval (time slot). When the time-based trigger event TRG_T and the packet-based trigger event TRG_P for different monitored WRED targets are simultaneously received by the controller 504, the controller 504 serves both of the time-based trigger event TRG_T and the packet-based trigger event TRG_P by triggering WRED operation units 512 and 514 respectively. Therefore, during the same time interval, the WRED operation unit 512 makes a WRED decision for one monitored WRED target (e.g., Port 0), and the other WRED operation unit 514 makes a WRED decision for a different monitored WRED target (e.g., Port 1). However, when the time-based trigger event TRG_T and the packet-based trigger event TRG_P for the same monitored WRED target (e.g., Port 0) are simultaneously received by the controller 504, a conflict would occur if the WRED operation units 512, 514 both try to make WRED decisions for the same monitored WRED target. To avoid the conflict issue, the controller 504 is configured to ignore the packet-based trigger event TRG_P without triggering the WRED operation unit 514. In other words, the controller 504 would serve the time-based trigger event TRG_T to trigger the WRED operation unit 512 only.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A random early drop (RED) based processing circuit, comprising:
a scheduler, configured to generate a trigger event according to an RED-based operation schedule, wherein the scheduler is coupled to a software interface (101), and the RED-based operation schedule in the scheduler is programmed via the software interface;
an RED-based decision logic, configured to perform at least a first RED-based operation to generate a first RED decision accordingly; and
a controller, configured to receive at least the trigger event, and trigger the RED-based decision logic to perform the first RED-based operation according to at least the trigger event.

2. The RED based processing circuit of claim 1, wherein the RED-based operation schedule is a weighted random early drop (WRED) operation schedule, the RED-based decision logic is a WRED decision logic, and the first RED-based operation is a WRED operation.

3. The RED based processing circuit of claim 1, wherein the trigger event is a time-based trigger event.

4. The RED based processing circuit of claim. 3, wherein the RED-based operation schedule includes a plurality of entries, each storing an index value of a monitored target; and the scheduler cyclically reads index values in the entries one by one to set and generate the time-based trigger event once in each of a plurality of time intervals.

5. The RED based processing circuit of claim 4, wherein the monitored target is a network port of a network device or a queue of the network port of the network device.

6. The RED based processing circuit of claim 5, wherein an index value of at least one network port or at least one queue is excluded from the RED-based operation schedule.

7. The RED based processing circuit of claim 3, wherein the controller is further configured to receive a packet-based trigger event; and the controller triggers the RED-based decision logic according to at least one of the time-based trigger event and the packet-based trigger event.

8. The RED based processing circuit of claim 7, wherein the packet-based trigger event is a packet arrival event.

9. The RED based processing circuit of claim 7, wherein the packet-based trigger event is a packet release event.

10. The RED based processing circuit of claim 7, wherein when the time-based trigger event and the packet-based trigger event are simultaneously received by the controller, the controller serves the packet-based trigger event first to trigger the RED-based decision logic.

11. The RED based processing circuit of claim 3, wherein the RED-based decision logic comprises:
a first RED-based operation unit, configured to perform the first RED-based operation to generate the first RED decision; and
a second RED-based operation unit, configured to perform a second RED-based operation to generate a second RED decision;
wherein the controller is further configured to receive a packet-based trigger event; the controller triggers the first RED-based operation unit according to the time-based trigger event, and triggers the second RED-based operation unit according to the packet-based trigger event.

12. The RED based processing circuit of claim 11, wherein when the time-based trigger event and the packet-based trigger event for a same monitored target are simultaneously received by the controller, the controller serves the time-based trigger event to trigger the first RED-based operation unit only.

13. A random early drop (RED) based processing method, comprising:
programming an RED-based operation schedule via a software manner;
generating a trigger event according to the RED-based operation schedule; and
referring to at least the trigger event for triggering an RED-based decision logic to perform at least a first RED-based operation to generate a first RED decision accordingly.

14. The RED based processing method of claim 13, wherein the RED-based operation schedule is a weighted random early drop (WRED) operation schedule, the RED-based decision logic is a WRED decision logic, and the first RED-based operation is a WRED operation.

15. The RED based processing method of claim 13, wherein the trigger event is a time-based trigger event.

16. The RED based processing method of claim 15, wherein the RED-based operation schedule includes a plurality of entries, each storing an index value of a monitored target; and the step of generating the time-based trigger event comprises:
cyclically reading index values in the entries one by one to set and generate the time-based trigger event once in each of a plurality of time intervals.

17. The RED based processing method of claim 16, wherein the monitored target is a network port of a network device or a queue of the network port of the network device.

18. The RED based processing method of claim 17, wherein an index value of at least one network port or at least one queue is excluded from the RED-based operation schedule.

19. The RED based processing method of claim 15, further comprising:
receiving a packet-based trigger event;
wherein the step of triggering the RED-based decision logic comprises:
triggering the RED-based decision logic according to at least one of the time-based trigger event and the packet-based trigger event.

20. The RED based processing method of claim 19, wherein the packet-based trigger event is a packet arrival event.

21. The RED based processing method of claim 19, wherein the packet-based trigger event is a packet release event.

22. The RED based processing method of claim 19, wherein when the time-based trigger event and the packet-based trigger event are simultaneously received, the packet-based trigger event is first served to trigger the RED-based decision logic.

23. The RED based processing method of claim 15, further comprising:
receiving a packet-based trigger event;
wherein the RED-based decision logic comprises:
a first RED-based operation unit, configured to perform the first RED-based operation to generate the first RED decision; and
a second RED-based operation unit, configured to perform a second RED-based operation to generate a second RED decision;
wherein the step of triggering the RED-based decision logic comprises:
triggering the first RED-based operation unit according to the time-based trigger event; and
triggering the second RED-based operation unit according to the packet-based trigger event.

24. The RED based processing method of claim 23, wherein when the time-based trigger event and the packet-based trigger event for a same monitored target are simultaneously received, only the time-based trigger event is served to trigger the first RED-based operation unit.
